(19) United States
(12) Patent Application Publication
(10) Pub. No.: US 2022/0046951 A1
(43) Pub. Date: Feb. 17, 2022

(54) PLANT PROTEIN-BASED WHOLE-CUT FRIED CHICKEN NUGGET AND PREPARATION METHOD THEREOF

(71) Applicant: Institute of Food Science and Technology, Chinese Academy of Agricultural Sciences, Beijing (CN)

(72) Inventors: Qiang WANG, Beijing (CN); Jinchuang ZHANG, Beijing (CN); Qiongling CHEN, Beijing (CN); Yujie ZHANG, Beijing (CN); Li LIU, Beijing (CN); Shi MENG, Beijing (CN)

(21) Appl. No.: 17/445,236

(22) Filed: Aug. 17, 2021

(30) Foreign Application Priority Data
Aug. 17, 2020 (CN) 2020108271204

(51) Int. Cl. A23J 3/26; A23J 3/18; A23J 3/22; A23L 27/40; A23L 27/26; A23L 5/10

(52) U.S. Cl. CPC A23J 3/26; A23J 3/18; A23J 3/227; A23V 2002/00; A23L 27/26; A23L 5/12; A23L 27/40

(57) ABSTRACT

A plant protein-based whole-cut fried chicken nugget is prepared from raw materials including peanut protein, wheat protein, seasonings, water-retaining agent, and coating flour in proportions measured in parts by weight. The preparation method of the plant protein-based whole-cut fried chicken nugget includes mixing the raw materials uniformly according to the proportions, subjecting to high-moisture extrusion treatment, boiling the resulted extrudate with water for an appropriate period, then coating with flour, placing in a frying pan at an appropriate temperature, and frying for an appropriate period. The plant protein-based whole-cut fried chicken nugget has a golden surface, a strong aroma, a crispy outside and tender inside, good elasticity and chewiness, no beany taste, high protein content, and rich nutrition.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

The present invention relates to the field of food processing, in particular to a plant protein-based whole-cut fried chicken nugget and a preparation method thereof.

### Description of the Related Art

In recent years, plant protein meat analogue has received more and more attention from researchers in the art. Plant protein meat analogue, also known as protein vegetarian meat or artificial meat, is actually a protein product that imitates the shape, color and taste of meat. Plant protein meat is prepared from protein as a raw material by heating, extruding, puffing and other processes. In the prior art, plant protein meat is usually prepared by the following method: (1) soybean cake: obtaining soybean cake after oil is extracted; (2) crushing: grinding the soybean cake into soybean flour by a mechanical mill; (3) blending: mixing raw materials and auxiliary materials according to the proportion of 25 kg of soybean flour, 20 g of edible caustic soda, 20 g of table salt and 1 kg of boiled water; and (4) extrusion puffing: putting the mixed materials into a puffing machine, pressurizing and heating to make the soybean flour dough fully cooked; and calendering into a 4 cm wide and 0.5 cm thick artificial meat strip.

However, the plant protein-based meat products prepared by the above-mentioned method still have many problems, such as loose fiber structure, poor juiciness, and beany taste.

In view of this, the present invention is provided.

### SUMMARY OF THE INVENTION

Aiming at the deficiencies in the prior art, the present invention provides a plant protein-based whole-cut fried chicken nugget and a preparation method thereof.

As a first purpose of the present invention, a plant protein-based whole-cut fried chicken nugget is provided, the plant protein-based whole-cut fried chicken nugget has a compact fiber structure, good elasticity and chewiness, good juiciness, no beany taste, and rich nutrition.

Specifically, the plant protein-based whole-cut fried chicken nugget is prepared from raw materials including the following ingredients in parts by weight: 20 to 50 parts of peanut protein, 30 to 60 parts of wheat protein, 0.1 to 0.5 parts of seasonings, 0.1 to 0.5 parts of water-retaining agent, and 0.5 to 1.5 parts of coating flour.

It is found in the present invention that a plant protein-based whole-cut fried chicken nugget can be prepared by using the above-mentioned raw materials, and the product has a golden surface, a strong aroma, and a crispy outside and a tender inside. In the present invention, peanut protein and wheat protein are selected as the protein raw materials, and the product's elasticity and chewiness are further improved by adjusting the proportion of the protein raw materials, so that the prepared plant protein-based whole-cut fried chicken nugget has a compact internal fiber structure, good elasticity, good taste, and the taste characteristics of chicken.

In order to further improve the quality of the plant protein-based whole-cut fried chicken nugget, the present invention optimizes the composition of its raw materials, specifically as follows: Preferably, the plant protein-based whole-cut fried chicken nugget is prepared from raw materials including the following ingredients in parts by weight: 35 to 48 parts of peanut protein, 40 to 60 parts of wheat protein, 0.3 to 0.4 parts of seasonings, 0.2 to 0.4 parts of water-retaining agent, and 0.9 to 1.3 parts of coating flour.

Preferably, the peanut protein has a content of protein of not less than 55%, and a content of fat of not more than 7.5%.

Preferably, the wheat protein has a content of protein of not less than 70%, and a content of fat of not more than 1.5%.

In the present invention, when peanut protein and wheat protein meet the above requirements, it is more favorable for the cross-linking effect between the two protein molecules, so that the fiber structure of the product is more compact.

Preferably, the seasonings are table salt and non animal-derived chicken flavor.

Compared to other seasonings, table salt and non animal-derived chicken flavor are more suitable for the raw material system of the present invention.

Further, the mass ratio of the table salt to the non animal-derived chicken flavor is (0.2 to 0.3):(0.05 to 0.1), more preferably 0.25:0.08 (especially ideal).

Preferably, the water-retaining agent is one or more selected from sodium phosphate, sodium tripolyphosphate, disodium hydrogen phosphate, and sodium hexametaphosphate. Compared to other water-retaining agents, the above-mentioned water-retaining agent is more suitable for the raw material system of the present invention. When the water retaining-agent is sodium tripolyphosphate, the effect is the best.

Preferably, the coating flour comprises wheat starch, xanthan gum and bread crumbs.

Preferably, the mass ratio of wheat starch:xanthan gum:bread crumbs is (0.2 to 0.5):(0.1 to 0.3):(0.3 to 0.6), wherein the xanthan gum is added in the form of a xanthan gum solution.

More preferably, 3 to 8% of spice is added to the wheat starch, and the spice is one or more of table salt, pepper powder, cumin powder, and rattan pepper powder.

In the present invention, the semi-finished product is wrapped with the above-mentioned coating flour, which is more beneficial to the shape and taste of the product.

As a second purpose of the present invention, a preparation method of the above-mentioned plant protein-based whole-cut fried chicken nugget is provided, which comprises the following steps:

(1) weighing peanut protein and wheat protein in proportion, adding seasonings and a water-retaining agent, stirring and mixing well; and

(2) subjecting the mixed material to high-moisture extrusion treatment.

The extrusion method for producing plant protein-based meat has the advantages of simple operation, high process integration and continuous production, and is currently the most widely used technology for preparing plant protein meat in the food industry. According to the different moisture content added in the extrusion process, the extrusion technology can be divided into low-moisture extrusion and high-moisture extrusion. It is found in the present invention that although the product prepared by low-moisture extrusion has certain flexibility and is easy to store, the product is loose and the processing process is complicated. It is further found in the present invention that the above-mentioned raw materials can be molded at one time by high-moisture extrusion technology, which has high process integration and is green and pollution-free, and the extrudate is cooked in the extruder barrer, which can shorten the subsequent frying time.

Preferably, the preparation method further comprises the step of frying:

(3) after boiling the extrudate subjected to high-moisture extrusion treatment with water for 4 to 6 min, evenly coating with wheat starch on the surface, rolling-over in a xanthan gum solution to make the surface evenly pasted, evenly coating the surface with bread crumbs, and frying in a frying pan.

The product prepared according to the above method has a golden surface, a strong aroma, a crispy outside and a tender inside.

In order to further improve the shape and taste of the plant protein-based whole-cut fried chicken nugget, the frying step is optimized in the present invention, specifically as follows: Preferably, the concentration of the xanthan gum solution is 0.3 to 0.8%; preferably 0.4 to 0.6%.

Preferably, the frying is carried out at 140° C. to 180° C. for 1 to 3 min, and preferably carried out at 140° C. to 160° C. for 2 to 3 min.

In the present invention, the water in the flour coated on the surface of the flour-coated semi-finished product quickly migrates and evaporates at a temperature ranging from 140° C. to 180° C. (especially 140° C. to 160° C.), to form a hard shell, which hinders the internal water in the plant protein-based chicken nugget from migrating and dissipating, thus forming a taste of crispy outside and tender inside. Furthermore, in the case of frying for 1 to 3 min (especially 2 to 3 min) at the above temperature range, the flour coated on the surface of the plant protein-based chicken nugget undergoes Maillard reaction and caramelization reaction, thus forming a golden appearance and endowing lipid flavor to the product.

The beneficial effects of the present invention are as follows:

In the present invention, by adjusting the proportion of raw materials of the plant protein-based whole-cut fried chicken nugget, and controlling the preparation parameters in the high-moisture extrusion process, the prepared plant protein-based whole-cut fried chicken nugget not only has a golden surface, a rich aroma, a crispy outside and a tender inside, good elasticity and chewiness, but also has no beany taste, high protein content and rich nutrition, which can provide vegetarians with more choices.

### BRIEF DESCRIPTION OF THE DRAWINGS

FIG. 1 shows the pictures of a plant protein-based whole-cut fried chicken nugget prepared in Example 1 of the present invention and the state of internal fibers thereof.

### DETAILED DESCRIPTION OF THE PREFERRED EMBODIMENT

The following Examples are intended to illustrate the present invention, but are not intended to limit the scope of the present invention. For the situation that the specific technology or conditions are not specified in the Examples, it shall be carried out according to the technology or conditions described in the literature in the art or according to the product specification. Those reagents or instruments with unspecified manufacture are all conventional products that can be purchased through formal channels.

A China-made twin-screw high moisture extruder is adopted for the extrusion texturization treatment in the following Examples.

The peanut protein and wheat protein used in the following Examples are both produced in China, and the basic physicochemical indexes thereof are shown in Table 1.

TABLE 1
Physicochemical indexes of peanut protein and wheat protein

| Items | Peanut protein | Wheat protein |
|---|---|---|
| Content of crude protein % | 65.25±0.42 | 72.15±0.84 |
| (×5.46 dry basis) | | |
| Content of crude fat % (dry basis) | 7.01±0.02 | 0.78±0.03 |
| Moisture % | 5.21±0.12 | 6.47±0.15 |

### Example 1

The present Example provides a plant protein-based whole-cut fried chicken nugget, which is prepared from the following raw materials in parts by weight: 45 parts of peanut protein, 53 parts of wheat protein, 0.25 parts of table salt, 0.08 parts of non animal-derived chicken flavor, 0.37 parts of sodium tripolyphosphate, and 1.3 parts of coating flour.

The coating flour consists of 0.5 parts of wheat starch, 0.3 parts of xanthan gum and 0.5 parts of bread crumbs. The wheat starch contains 0.04 parts of rattan pepper powder. The present Example also provides a preparation method of the above-mentioned plant protein-based whole-cut fried chicken nugget, which specifically comprises the following steps:

(1) peanut protein and wheat protein were weighed in proportion, seasonings and a water-retaining agent were added, the resultant was stirred and mixed well;

(2) the mixed material was subjected to high-moisture extrusion treatment; and

(3) the extrudate was boiled with water for 5 min, then evenly coated with wheat starch, and rolled over in a xanthan gum solution with a concentration of 0.4% to make the surface evenly pasted; the surface was evenly coated with bread crumbs, the resultant was fried in a frying pan at 160° C. for 2 min, ant then taked out and cooled to obtain the plant protein-based whole-cut fried chicken nugget.

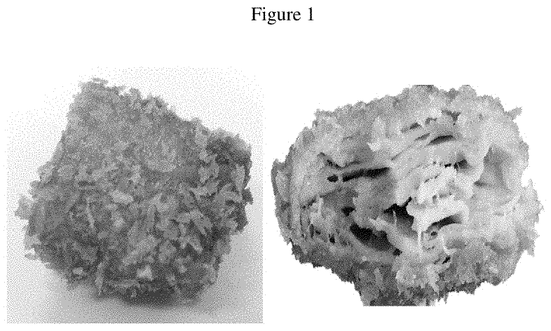

The actual picture of the plant protein-based whole-cut fried chicken nugget prepared in the present Example is shown in FIG. 1, and it can be seen that the appearance and internal fiber state thereof are very close to a real golden fried chicken nugget.

### Example 2

The present Example provides a plant protein-based whole-cut fried chicken nugget, which is prepared from the following raw materials in parts by weight: 38 parts of peanut protein, 60 parts of wheat protein, 0.25 parts of table salt, 0.08 parts of non animal-derived chicken flavor, 0.37 parts of sodium tripolyphosphate, and 0.9 parts of coating flour.

The coating flour consists of 0.3 parts of wheat starch, 0.2 parts of xanthan gum and 0.4 parts of bread crumbs. The wheat starch contains 0.01 parts of rattan pepper powder.

The preparation method of the above plant protein-based whole-cut fried chicken nugget is the same as that in Example 1.

### Example 3

The present Example provides a plant protein-based whole-cut fried chicken nugget, which is different from Example 1 in that the temperature for frying is 140° C.

### Example 4

The present Example provides a plant protein-based whole-cut fried chicken nugget, which is different from Example 1 in that the time for frying is 3 min Comparative Example 1

The present Comparative Example provides a plant protein-based whole-cut fried chicken nugget, which is different from Example 1 in the follows: the content of the peanut protein is 70 parts, and the content of the wheat protein is 28 parts Comparative Example 2

The present Comparative Example provides a plant protein-based whole-cut fried chicken nugget, which is different from Example 1 in that the wheat starch is replaced with pea starch.

### Comparative Example 3

The present Comparative Example provides a plant protein-based whole-cut fried chicken nugget, which is different from Example 1 in that the xanthan gum solution is replaced with 0.2 parts of egg white.

### Comparative Example 4

The present Comparative Example provides a plant protein-based whole-cut fried chicken nugget, which is different from Example 1 in that the temperature for frying is 200° C.

### Comparative Example 5

The present Comparative Example provides a plant protein-based whole-cut fried chicken nugget, which is different from Example 1 in that the time for frying is 4 min Experimental Example 1

Sensory evaluation comparison was made on the plant protein-based whole-cut fried chicken nuggets prepared in Examples 1 to 4 and Comparative Examples 1 to 5, and the results were shown in Table 2.

The measurement of indicators for sensory evaluation refers to the following documents:

1. Zhu Song. Study on preparation of peanut protein vegetarian sausage based on high-moisture extrusion technology and storage characteristics thereof [D]. Mt Chinese Academy of Agricultural Sciences, 2019.

2. Yang Xiaoyu. Research on the development of soybean tissue protein vegetarian food [D]. Northeast Agricultural University, 2005.

TABLE 2
Comparison results of sensory evaluation

| | Indicators | | |
|---|---|---|---|
| No. | Appearance | Flavor | Taste |
| Example 1 | Golden | Good | Moderate |
| Example 2 | Golden | Good | Relatively soft |
| Example 3 | Yellow | Relatively good | Moderate |
| Example 4 | Golden | Relatively good | Moderate |
| Comparative Example 1 | Golden | Relatively poor | Relatively soft |
| Comparative Example 2 | Golden | Relatively good | Hard |
| Comparative Example 3 | Golden | Good | Moderate |
| Comparative Example 4 | Scorched | Poor | Relatively hard |
| Comparative Example 5 | Yellowish brown | Relatively poor | Relatively hard |

Although the general description, specific embodiments and experiments have been used to describe the present invention in detail above, some modifications or improvements can be made on the basis of the present invention, which is obvious to a person skilled in the art. Therefore, all these modifications or improvements made without departing from the spirit of the present invention belong to the scope of the present invention.

What is claimed is:

1. A plant protein-based whole-cut fried chicken nugget, wherein the plant protein-based whole-cut fried chicken nugget is prepared from raw materials including the following ingredients in parts by weight: 20 to 50 parts of peanut protein, 30 to 60 parts of wheat protein, 0.1 to 0.5 parts of seasonings, 0.1 to 0.5 parts of water-retaining agent, and 0.5 to 1.5 parts of coating flour.

2. The plant protein-based whole-cut fried chicken nugget according to claim 1, wherein the plant protein-based whole-cut fried chicken nugget is prepared from raw materials including the following ingredients in parts by weight: 35 to 48 parts of peanut protein, 40 to 60 parts of wheat protein, 0.3 to 0.4 parts of seasonings, 0.2 to 0.4 parts of water-retaining agent, and 0.9 to 1.3 parts of coating flour.

3. The plant protein-based whole-cut fried chicken nugget according to claim 1, wherein the peanut protein has a content of protein of not less than 55%, and a content of fat of not more than 7.5%; and/or
the wheat protein has a content of protein of not less than 70%, and a content of fat of not more than 1.5%.

4. The plant protein-based whole-cut fried chicken nugget according to claim 2, wherein the peanut protein has a content of protein of not less than 55%, and a content of fat of not more than 7.5%; and/or
the wheat protein has a content of protein of not less than 70%, and a content of fat of not more than 1.5%.

5. The plant protein-based whole-cut fried chicken nugget according to claim 1, wherein the seasonings are table salt and non animal-derived chicken flavor.

6. The plant protein-based whole-cut fried chicken nugget according to claim 2, wherein the seasonings are table salt and non animal-derived chicken flavor.

7. The plant protein-based whole-cut fried chicken nugget according to claim 1, wherein the water-retaining agent is one or more selected from sodium phosphate, sodium tripolyphosphate, disodium hydrogen phosphate, and sodium hexametaphosphate.

8. The plant protein-based whole-cut fried chicken nugget according to claim 2, wherein the water-retaining agent is one or more selected from sodium phosphate, sodium tripolyphosphate, disodium hydrogen phosphate, and sodium hexametaphosphate, preferably sodium tripolyphosphate.

9. The plant protein-based whole-cut fried chicken nugget according to claim 1, wherein the coating flour comprises wheat starch, xanthan gum and bread crumbs;
preferably, the mass ratio of wheat starch:xanthan gum:bread crumbs is (0.2 to 0.5):(0.1 to 0.3):(0.3 to 0.6);
more preferably, 3 to 8% of spice is added to the wheat starch, and the spice is one or more of table salt, pepper powder, cumin powder, and rattan pepper powder.

10. The plant protein-based whole-cut fried chicken nugget according to claim 2, wherein the coating flour comprises wheat starch, xanthan gum and bread crumbs;
preferably, the mass ratio of wheat starch:xanthan gum:bread crumbs is (0.2 to 0.5):(0.1 to 0.3):(0.3 to 0.6);
more preferably, 3 to 8% of spice is added to the wheat starch, and the spice is one or more of table salt, pepper powder, cumin powder, and rattan pepper powder.

11. A preparation method of the plant protein-based whole-cut fried chicken nugget according to claim 1, comprising:
(1) weighing peanut protein and wheat protein in proportion, adding seasonings and a water-retaining agent, stirring and mixing well; and
(2) subjecting the mixed material to high-moisture extrusion treatment.

12. The preparation method according to claim 11, further comprising:
(3) frying after boiling the extrudate subjected to high-moisture extrusion treatment with water for 4 to 6 min, evenly coating with wheat starch on the surface, rolling-over in a xanthan gum solution to make the surface evenly pasted, evenly coating the surface with bread crumbs, and frying in a frying pan.

13. The preparation method according to claim 12, wherein the concentration of the xanthan gum solution is 0.3 to 0.8%, preferably 0.4 to 0.6%.

14. The preparation method according to claim 12, wherein the frying is carried out at 140° C. to 180° C. for 1 to 3 min, preferably at 140° C. to 160° C. for 2 to 3 min.

15. The plant protein-based whole-cut fried chicken nugget according to claim 5, wherein the mass ratio of the table salt to the non animal-derived chicken flavor is (0.2 to 0.3):(0.05 to 0.1).

16. The plant protein-based whole-cut fried chicken nugget according to claim 5, wherein the mass ratio of the table salt to the non animal-derived chicken flavor is 0.25:0.08.

17. The plant protein-based whole-cut fried chicken nugget according to claim 6, wherein the mass ratio of the table salt to the non animal-derived chicken flavor is (0.2 to 0.3):(0.05 to 0.1).

18. The plant protein-based whole-cut fried chicken nugget according to claim 6, wherein the mass ratio of the table salt to the non animal-derived chicken flavor is 0.25:0.08.

19. The plant protein-based whole-cut fried chicken nugget according to claim 1, wherein the water-retaining agent is sodium tripolyphosphate.

20. The plant protein-based whole-cut fried chicken nugget according to claim 2, wherein the water-retaining agent is sodium tripolyphosphate
